(19) United States
(12) Patent Application Publication
(10) Pub. No.: US 2025/0376616 A1
(43) Pub. Date: Dec. 11, 2025

(54) METHOD AND COMPOSITIONS FOR DRAG REDUCER IN DOWNHOLE APPLICATIONS

(71) Applicants: Saudi Arabian Oil Company, Dhahran (SA); King Fahd University of Petroleum & Minerals, Dhahran (SA)

(72) Inventors: Rajendra Arunkumar Kalgaonkar, Dhahran (SA); Amro Othman, Al Khobar (SA); Mohamed Mahmoud, Dhahran (SA); Murtada Saleh Aljawad, Dhahran (SA); Muhammed Shahzad Kamal, Dhahran (SA); Qasim Sahu, Muntazah (SA)

(21) Appl. No.: 18/734,039

(22) Filed: Jun. 5, 2024

(51) Int. Cl. C09K 8/68; C09K 8/88

(52) U.S. Cl. CPC C09K 8/68; C09K 8/885; E21B 43/26; C09K 2208/28

(57) ABSTRACT

A composition for use in well stimulation operations, the composition comprising a saline fluid, the saline fluid comprising between 50,000 ppm and 70,000 ppm; a polymer, the polymer operable to hydrate in the saline fluid such that it increases the viscosity of the saline fluid react with a chelating agent, the chelating agent comprises L-glutamic acid N, N diacetic acid (GLDA), wherein the GLDA is present in an amount between 1 wt % and 20 wt %.

At a pH greater than 10, precipitation of Ca²⁺ and Mg²⁺ ions is expected forming different scales. Therefore, scale inhibitors should be used, and pH should be controlled to avoid scale precipitation. Additionally, saltwater thermal stability should also be monitored carefully.

### SUMMARY

Disclosed are compositions and methods for hydraulic fracturing treatments. Specifically, disclosed are compositions and methods for hydraulic fracturing treatments that can delay viscosity increase in high salinity waters.

In a first aspect, a composition for use in well stimulation operations is provided. The composition includes a saline fluid, the saline fluid includes between 50,000 ppm and 70,000 ppm, a polymer, the polymer operable to hydrate in the saline fluid such that it increases the viscosity of the saline fluid, and a chelating agent, the chelating agent includes L-glutamic acid N, N diacetic acid (GLDA), where the GLDA is present in an amount between 1 wt % to 20 wt %.

In certain aspects, the saline fluid can be selected from the group consisting of seawater, produced water, and combinations of the same. In certain aspects, the polymer includes carboxymethyl hydroxypropyl guar (CMHPG) polymer. In certain aspects, the polymer is present in an amount between 0.5 wt % and 0.6 wt %. In certain aspects, the chelating agent is present in an amount between 1 wt % and 10 wt %. In certain aspects, the composition has a viscosity in the range between 30 cP and 50 cP. In certain aspects, the composition has a viscosity in the range between 30 cP and 50 cP after 10 hours. In certain aspects, the pH is between 11 and 14. In certain aspects, the composition further comprises proppant.

A method of using a hydraulic fracturing fluid, the method includes the steps of injecting the hydraulic fracturing fluid into a formation during a well stimulation operation, where the hydraulic fracturing fluid includes a saline fluid, the saline fluid includes between 50,000 ppm and 70,000 ppm, a polymer, the polymer operable to hydrate in the saline fluid such that it increases the viscosity of the saline fluid, and a chelating agent, the chelating agent includes diethylenetriaminepentaacetic acid (L-glutamic acid N, N diacetic acid (GLDA), where the GLDA is present in an amount between 1 wt % and 10 wt %, and where the hydraulic fracturing fluid has a viscosity between 1 cP and 30 cP before reaching the formation and a viscosity of between 30 cP and 50 cP after reaching the formation.

In certain aspects, the well stimulation operation is selected from the group consisting of fracturing and proppant transport. In certain aspects, the saline fluid can be selected from the group consisting of seawater, produced water, and combinations of the same.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is a graph depicting viscosity over time for mixtures of 0.5 wt % CMHPG polymer and 13.7 pH GLDA in seawater at different GLDA concentrations in different pressure cell at 25° C., 511 l/s and 500 psi (3447.4 kPa).

FIG. 2 is a graph depicting viscosity over time for mixtures of 0.5 wt % CMHPG polymer with 10 wt % and different chelating agents pH in a pressure cell at 70° C., 100 l/s and 500 psi (3447.4 kPa).

FIG. 3 is a graph depicting viscosity over time for mixtures of 0.5 wt % CMHPG polymer with fluids of different salt ions.

FIG. 4 is a graph depicting viscosity over time for mixtures of 0.5 wt % CMHPG polymer with fluids of different salt ions.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The composition and methods delay increase in viscosity in high salinity waters in fracturing fluid treatments. Advantageously, the compositions reduce pressure loss by reducing friction pressures during the pumping of the fracturing fluid into the formation due to the delayed viscosity increase. High viscosity fracturing fluids are desired in hydraulic fracturing to propagate fractures and transport proppant into the formation, thus the delayed viscosity fluids reduce wear and tear on the pump, while achieving the desired results.

As used throughout, “high salinity” means a fluid having a total dissolved solids greater than 50,000 ppm.

As used throughout, “drag reducer” is a material that reduces frictional pressure loss in a flowing fluid.

The hydraulic fracturing fluid includes a saline fluid, a polymer, and a chelating agent.

The saline fluid be any high salinity water. The saline fluid can include seawater, produced water, and combinations of the same. The saline fluid can have a total dissolved solids of greater 50,000 ppm, alternately between 50,000 ppm and 70,00 ppm, alternately 67,700 ppm.

The polymer acts as a gelling agent increasing the viscosity as it hydrates in the saline fluid. The polymer can be a carboxymethyl hydroxypropyl guar (CMHPG) polymer. The CMHPG polymer can be present in amount between 0.5 wt % and 0.6 wt %, and alternately in an amount of 0.5 wt %. Amounts greater than 0.6 wt % can cause formation damage. Additionally, at amounts greater than 0.6 wt % the drag reduction differs. The amount of CMHPG can be controlled by field application standards not to exceed 50 pounds per thousand gallons (pptg) (5.99 kg/m³). Advantageously, CMHPG has compatibility with high and low-pH environments, such that regardless of the pH it has better hydration and slow degradation.

Chelating agents can delay the viscosification due to the pH of the fluid. Advantageously, the chelating agent can capture ions and soften the saline water, while reducing drag and reducing formation damage and equipment damage, and in addition the hydraulic fracturing fluid can have improved thermal stability over a fluid in the absence of a chelating agent. The chelating agent can be L-glutamic acid N, N diacetic acid (GLDA). The GLDA can be selected from a high pH GLDA, a low pH GLDA, and combinations of the same. The high pH GLDA can have a pH in the range of 11 to 13.7 and a chemical structure according to formula (I):

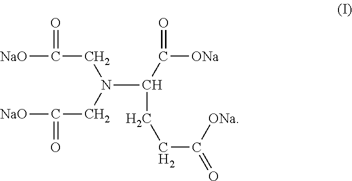

The low pH GLDA can have a pH in the range of 3.4 to 4 and have a chemical structure of formula (II):

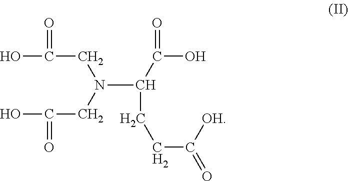 [SMILES: O=C(O)CCC(C(=O)O)N(CC(=O)O)CC(=O)O]

The chelating agent can increase the pH of the hydraulic fracturing fluid thus delaying viscosification. Alternately, the pH of the chelating agent can be modified with sodium hydroxide to achieve the desired pH prior to addition to the hydraulic fracturing fluid. The chelating agent can be present in an amount between 1 wt % and 20 wt %, 1 wt % and 10 wt %, 1 wt % and 4 wt %, and alternately between 5 wt % and 10 wt %. At amounts greater than 10 wt %, the excess GLDA can begin to affect the hydration and at amounts greater than 20 wt %, the viscosity does not increase. The GLDA can act as a drag reducer by delaying the viscosity increase of the hydraulic fracturing fluid until after the hydraulic fracturing fluid is pumped into the formation. Advantageously, the GLDA softens the saline water and captures the ions preventing salt precipitation. Advantageously, GLDA can provide scale inhibition resulting in the need for fewer additives.

The pH of the hydraulic fracturing fluid can be between 10 and 14, alternately between 11 and 14, alternately between 11.5 and 14, alternately between 12 and 14, and alternately between 13 and 14. Drag reduction can begin at pH greater than 10. In at least one embodiment, the desired pH is achieved by adding the chelating agent. In at least one embodiment, the desired pH is achieved by adding the chelating agent and sodium hydroxide. Selecting the pH of the hydraulic fracturing fluid results controls the duration of the low-viscosity region.

In at least one embodiment, the hydraulic fracturing fluid includes seawater, CMHPG polymer, and a high pH GLDA chelating agent. In at least one embodiment, the hydraulic fracturing fluid includes seawater, CMHPG polymer, a low pH GLDA chelating agent, and sodium hydroxide. The results show that fluids can be formulated using sea water, CMHPG polymer, and GLDA chelating agents with delayed viscosification suitable for use in hydraulic fracturing treatments. Advantageously, the hydraulic fracturing fluids described herein reduces the required pressure to pump the saline fluid to the formation while viscosification occurs when it enters the formation without further action or additives.

The hydraulic fracturing fluid can have a viscosity in the range between 30 cP and 50 cP. The hydraulic fracturing fluid can have a viscosity in the range between 30 cP and 50 cP after 10 hours.

The hydraulic fracturing fluid can include a proppant. Any proppant suitable for use in a hydraulic fracturing fluid can be used.

The hydraulic fracturing fluid can be used for well stimulation operations, including fracturing and proppant transport. Advantageously, the hydraulic fracturing fluid prevents or reduces formation damage by preventing scales and precipitated ions.

The hydraulic fracturing fluid is in the absence of ethylenediaminetetraacetic acid (EDTA), diethylenetriaminepentaacetic acid (DTPA), and polyvinyl alcohol. The hydraulic fracturing fluids are in the absence of emulsions. The hydraulic fracturing fluid is in the absence of an emulsion. The hydraulic fracturing fluid is in the absence of a foam.

### EXAMPLE

Experiments to produce hydraulic fracturing fluid compositions were performed. The experiments were conducted using seawater with a CMHPG polymer, and GLDA chelating agent. The composition of the seawater is shown in Table 1 in grams per liter.

TABLE 1
Individual salts and total salts in seawater.

| Components | Concentration (g/l) |
|---|---|
| NaHCO₃ | 0.165 |
| Na₂SO₄ | 6.339 |
| NaCl | 41.172 |
| CaCl₂•2H₂O | 2.387 |
| MgCl₂•6H₂O | 17.644 |
| Total Dissolved Solids | 67.707 |

The CMHPG polymer was XLFC-3B obtained from Baker Hughes Inc. Houston, TX. The chelating agent was a high and low pH Dissolvine® StimWell DGH GLDA of 40% active content obtained from Nouryon, Houston, TX. The high pH GLDA had a pH of 13.7. The low pH GLDA had a pH of 4. The pH of the low pH GLDA was adjusted with sodium hydroxide.

### Experimental Design

The CMHPG polymer, at a concentration of 0.5 wt %, was hydrated in seawater for at least 40 minutes for each fluid. The chelating agent was added to the hydrated polymer and mixed for 5 minutes. In the first set of experiments, the high pH GLDA was used at four different concentrations: 1 wt %, 3 wt %, 5 wt %, and 10 wt %. In the second set of experiments, the pH of 10 wt % of the low pH GLDA was increased with sodium hydroxide. In the first two sets of experiments the tests were conducted with an Anton Paar-MCR 302 rheometer at 25° C. and standard pressure and a shear rate of 511 1/s. In a third set of experiments, 0.6 wt % CMHPG along with 10 wt % and 20 wt % of the high pH GLDA each were added to seawater, deionized water, and individual ion solutions, including calcium chloride, sodium chloride, magnesium chloride, and sodium sulfate. In this third experiment, each solution was tested in the Anton Paar-MCR 302 rheometer at 70° C., 500 psi (3447.4 kPa), and 100 l/s shear rate.

### Results and Discussion

### Experiment #1—High pH GLDA

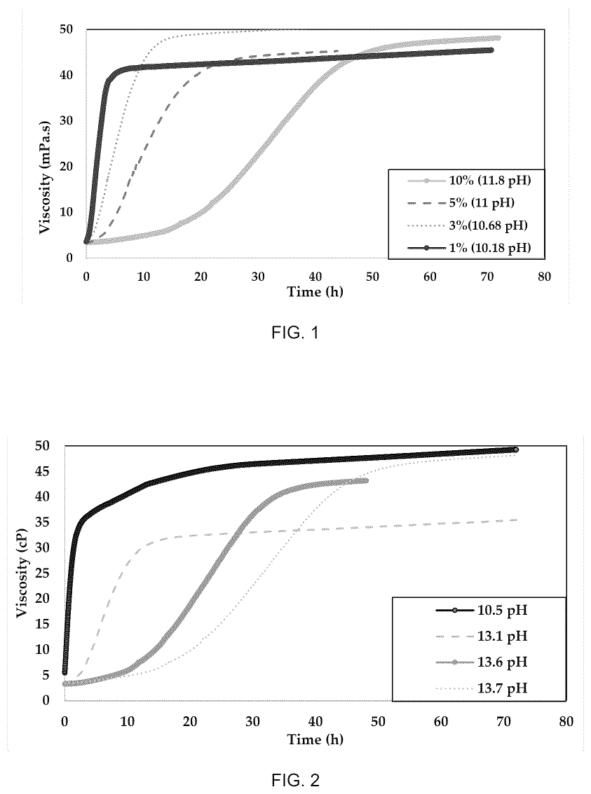

Mixtures were prepared according to the experimental designed described with 1 wt %, 3 wt %, 5 wt %, and 10 wt % high pH GLDA. The pH of the fluid with 1 wt % was 10.18, the pH of the fluid with 3 wt % was 10.68, the pH of the fluid with 5 wt % was 11, and the pH with 10 wt % was 11.8. The results of rheology tests are shown in FIG. 1, seawater-based viscosity versus time. The results show different delayed hydration of polymer behaviors. In addition, the results show that viscosity starts at low values, for example 3 mPa·s to 5 mPa·s, and reaches values greater than 40 mPa·s after shearing for a couple of hours. At later shearing times, the high pH GLDA viscosity increases gradually.

### Experiment #2—Constant Concentration Low pH GLDA

Mixtures were prepared according to the experimental designed described with 10 wt % low pH GLDA. The pH of the low pH GLDA was adjusted using sodium hydroxide. The adjusted pH of the GLDA and the pH of the final mixture are shown in Table 2.

TABLE 2
Adjusted pH of chelating agent and mixture

| Sample | Adjusted pH of GLDA | Final pH of the sample |
|---|---|---|
| 1 | 10.5 | 9.5 |
| 2 | 13.1 | 10.3 |
| 3 | 13.6 | 10.9 |
| 4 | 13.7 | 11.6 |

The results of the rheology tests are shown in FIG. 2, viscosity versus time. As the pH of the GLDA increase, the increase in viscosity takes longer durations to appear.

The results, including FIG. 1 and FIG. 2 show that fluids with lower concentrations of GLDA and higher pH can work as effectively at delaying viscosity increase as higher concentrations of GLDA. Greater concentrations of high pH GLDA or high pH increases the time before viscosity increases.

### Experiment #3—Salt Ions

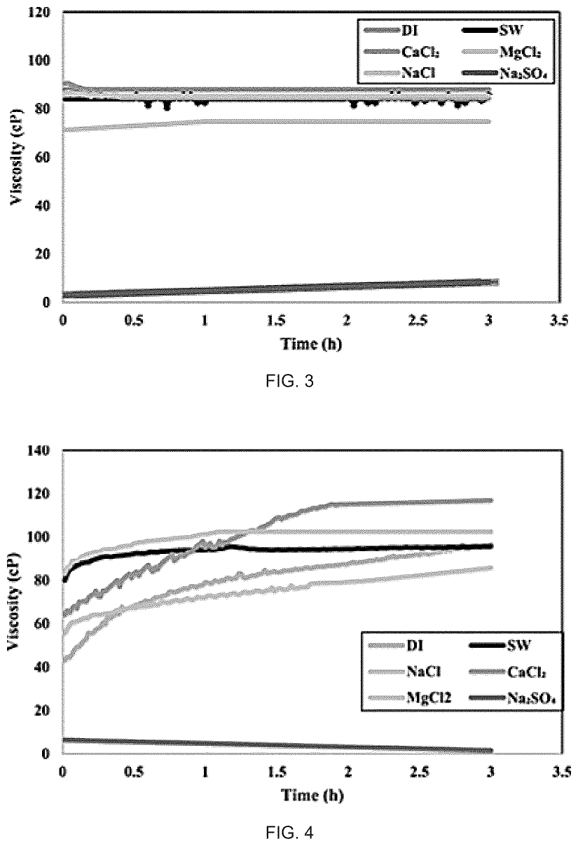

Mixtures were prepared according to the experimental designed described with different fluids sweater, deionized water, fluids containing calcium chloride (CaCl₂), sodium chloride (NaCl), magnesium chloride (MgCl₂), and sodium sulfate (Na₂SO₄). FIG. 3 shows the results with 10 wt % GLDA concentration as viscosity over time. FIG. 4 shows the results with 20 wt % GLDA concentration as viscosity over time.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

1. A composition for use in well stimulation operations, the composition comprising:
a saline fluid, the saline fluid comprising between 50,000 ppm and 70,000 ppm;
a polymer, the polymer operable to hydrate in the saline fluid such that it increases the viscosity of the saline fluid;
chelating agent, the chelating agent comprises L-glutamic acid N, N diacetic acid (GLDA), wherein the GLDA is present in an amount between 1 wt % and 20 wt %.

2. The composition of claim 1, wherein the saline fluid can be selected from the group consisting of seawater, produced water, and combinations of the same.

3. The composition of claim 1, wherein the polymer comprises carboxymethyl hydroxypropyl guar (CMHPG) polymer.

4. The composition of claim 1, wherein the polymer is present in an amount between 0.5 wt % and 0.6 wt %.

5. The composition of claim 1, wherein the composition has a viscosity in the range between 30 cP and 50 cP.

6. The composition of claim 1, wherein the composition has a viscosity in the range between 30 cP and 50 cP after 10 hours.

7. The composition of claim 1, wherein the pH is between 11 and 14.

8. The composition of claim 1, further comprising proppant.

9. A method of using a hydraulic fracturing fluid, the method comprising the step of:
injecting the hydraulic fracturing fluid into a formation during a well stimulation operation, wherein the hydraulic fracturing fluid comprises:
a saline fluid, the saline fluid comprising between 50,000 ppm and 70,000 ppm;
a polymer, the polymer operable to hydrate in the saline fluid such that it increases the viscosity of the saline fluid; and
a chelating agent, the chelating agent comprises L-glutamic acid N, N diacetic acid (GLDA), wherein the GLDA is present in an amount between 1 wt % and 20 wt %;
wherein the hydraulic fracturing fluid has a viscosity between 1 cP and 30 cP before reaching the formation and a viscosity of between 30 cP and 50 cP after reaching the formation.

10. The method of claim 9, wherein the hydraulic fracturing fluid further comprises proppant.

11. The method of claim 9, wherein the well stimulation operation is selected from the group consisting of fracturing and proppant transport.

12. The method of claim 9, wherein the saline fluid can be selected from the group consisting of seawater, produced water, and combinations of the same.

13. The method of claim 9, wherein the polymer comprises carboxymethyl hydroxypropyl guar (CMHPG) polymer.

14. The method of claim 9, wherein the chelating agent is present in an amount between 1 wt % and 10 wt %.
